(19) United States
(12) Patent Application Publication
(10) Pub. No.: US 2014/0165757 A1
(43) Pub. Date: Jun. 19, 2014

(54) POSITIONING DEVICE

(71) Applicant: Moog Inc., East Aurora, NY (US)

(72) Inventors: James R. Lutz, Gurnee, IL (US); Stephan H. Wyatt, Crystal Lake, IL (US); Carl C. Diana, Round Lake, IL (US)

(73) Assignee: Moog Inc., East Aurora, NY (US)

(21) Appl. No.: 13/714,698

(22) Filed: Dec. 14, 2012

(51) Int. Cl. F16H 1/22

(52) U.S. Cl. CPC F16H 1/222
USPC 74/412 R

(57) ABSTRACT

An adjustable head for use in connection with a tripod including a housing and an internal pan adjustment gear configured to rotate the housing around a first axis and a tilt adjustment gear configured to rotate the housing around a second axis, perpendicular to the first axis. A pan adjustment knob is connected with respect to the pan adjustment gear that permits a continuous and infinite coarse adjustment and a continuous and infinite fine adjustment of the pan adjustment gear, wherein locking the coarse adjustment enables the fine adjustment.

### BACKGROUND OF THE INVENTION

1. Field of the Invention

This invention relates to an adjustable head having continuous and infinite fine and coarse rotation capabilities.

2. Description of Related Art

Positioning devices, such as the adjustable heads described herein, are commonly moveable housings that support one or more components on the top of a mounting surface, such as a tripod. As used herein, a positioning device is an adjustable head that enables one or more components to be moved into a desired fixed position and/or through one or more moveable routines. The positioning device according to this invention is preferably a tripod head used in connection with a tripod and a component that requires both a panning and tilting placement, including sighting devices, like telescopes and binoculars and cameras; thermal imaging equipment; lasers; weapon systems; antennas; monitoring systems for security, control, interaction, measurement; and other applications requiring active or passive monitoring of a particular environment.

A need exists for an adjustable head, such as a tripod head, that permits adjustment in both pan and tilt directions using coarse and fine adjustment in a continuous manner. Prior art adjustable heads exist that permit a limited fine adjustment before the head needs to be readjusted either by physically moving the entire mounting surface or through resetting of the coarse adjustment. Such readjustments may not always be practical or safe in a combat environment or similar high-stress, fast-moving situation. More particularly, a need exists to adjust coarse and fine adjustment continuously and through an infinite path.

### SUMMARY OF THE INVENTION

The positioning device according to a preferred embodiment of this invention may be an adjustable head, such as a tripod head, for accommodating one or more sighting devices, cameras, imaging equipment, weapon systems, measuring system, surveillance system or any other similar component known to those having ordinary skill in the art.

The positioning device according to this invention includes a housing that may be connected at a base to a mounting surface, such as a tripod, and includes a platform for mounting the desired accessory or device. A pan adjustment gear is positioned within the housing and is configured to rotate the housing around a first axis normal (or perpendicular) to the base. A tilt adjustment gear is also positioned within the housing and is configured to rotate the housing around a second axis relative to the base, perpendicular to the first axis.

A pan adjustment knob is mechanically connected with respect to the pan adjustment gear and permits a continuous and infinite coarse adjustment and a continuous and infinite fine adjustment of the pan adjustment gear. A coupler is additionally provided within the house wherein locking the coarse adjustment with the coupler enables the fine adjustment. According to a preferred embodiment, a tilt adjustment knob is additionally provided that controls fine adjustment of the tilt adjustment gear in a continuous manner within a possible range of tilt travel.

In addition, the subject invention preferably includes a continuous feedback system wherein a tilt feedback gear and a pan feedback gear are each connected with respect to a respective feedback device to enable continuous feedback. In this manner, the adjustable head may be infinitely adjusted and still maintain a constant position for external control and documentation.

### BRIEF DESCRIPTION OF THE DRAWINGS

The above-mentioned and other features and objects of this invention will be better understood from the following detailed description taken in conjunction with the drawings wherein:

FIG. 1 is a left side perspective view of an adjustable head according to one preferred embodiment of this invention;

FIG. 2 is a top view of the adjustable head shown in FIG. 1;

FIG. 3 is a cross-sectional view taken along Section 3-3 of FIG. 2 of the adjustable head shown in FIG. 1;

FIG. 4 is a left side view of the adjustable head shown in FIG. 1;

FIG. 5 is a cross-sectional view taken along Section 5-5 of FIG. 4 of the adjustable head shown in FIG. 1;

FIG. 6 is a front view of the adjustable head shown in FIG. 1;

FIG. 7 is a left side perspective view of a partial assembly of a portion of the internal mechanisms of the adjustable head shown in FIG. 1;

FIG. 8 is a right side perspective view of a partial assembly of a portion of the internal mechanisms of the adjustable head shown in FIG. 1;

FIG. 9 is a front perspective view of a tripod used in connection with an adjustable head according to one preferred embodiment of this invention;

FIG. 10 is a top view of an adjustable head according to one preferred embodiment of this invention; and

FIG. 11 is a cross-sectional view taken along Section 11-11 of FIG. 10.

### DESCRIPTION OF PREFERRED EMBODIMENTS

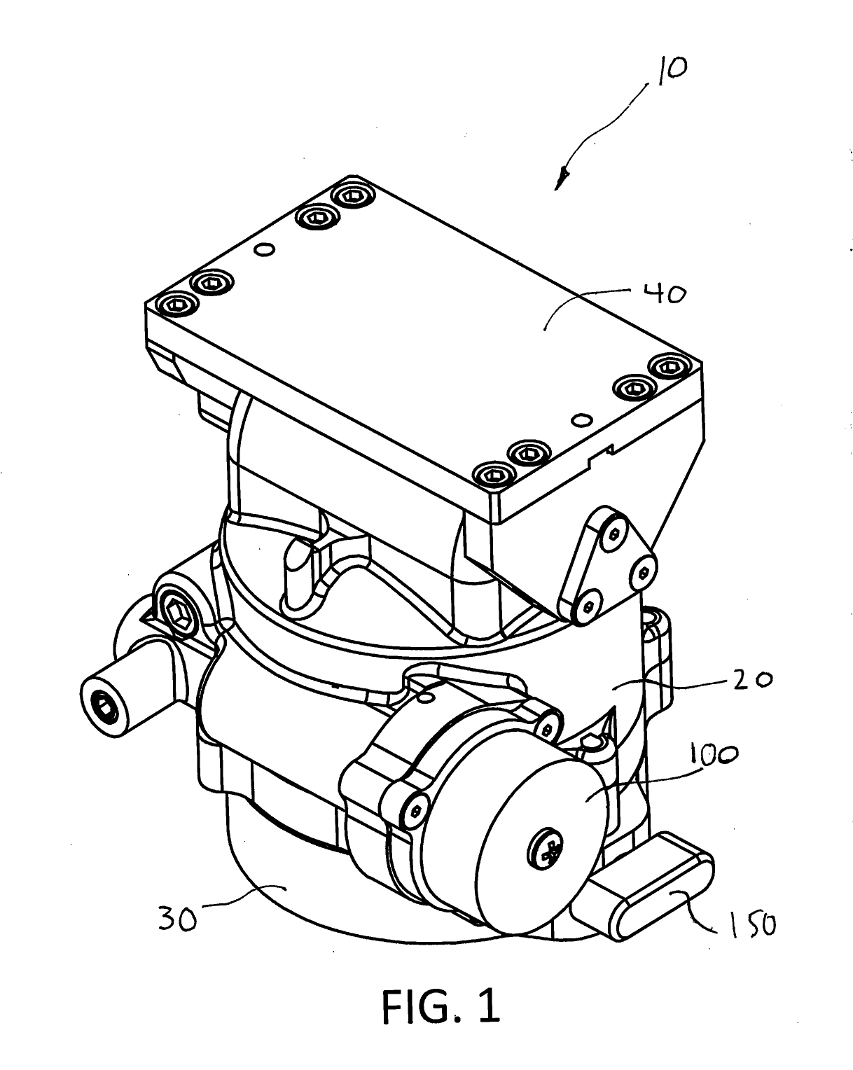

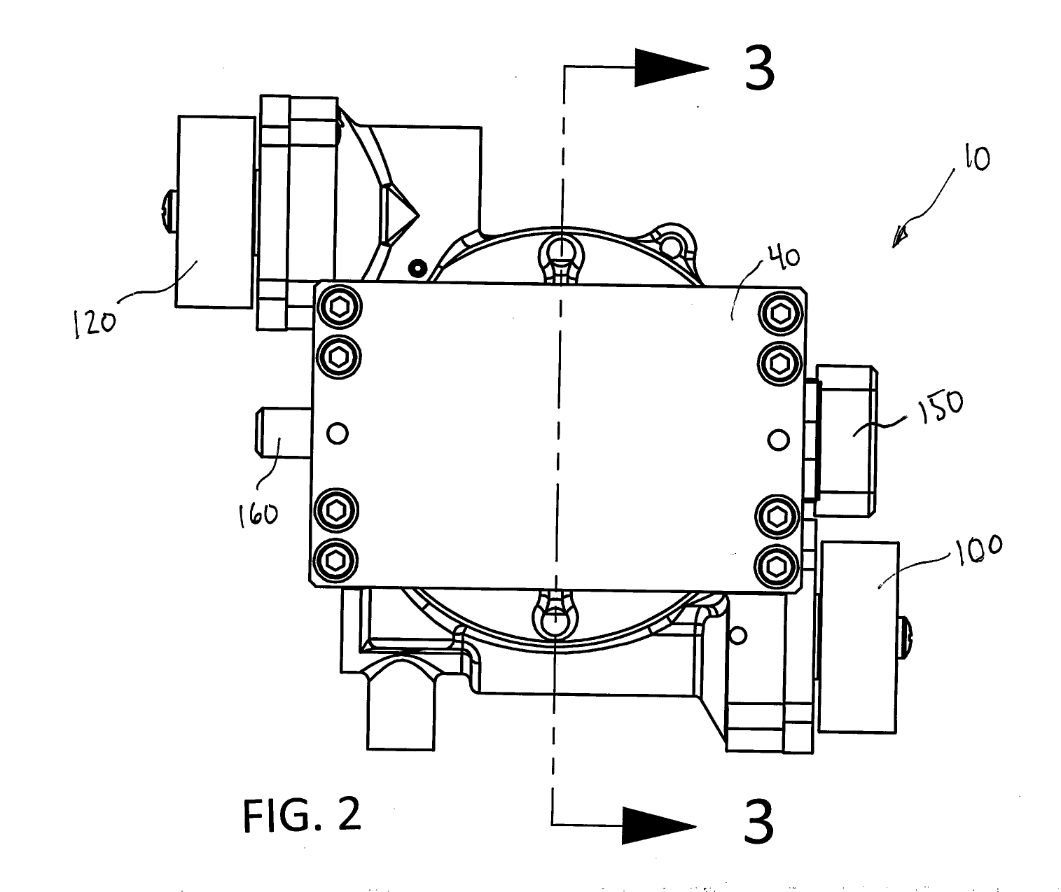

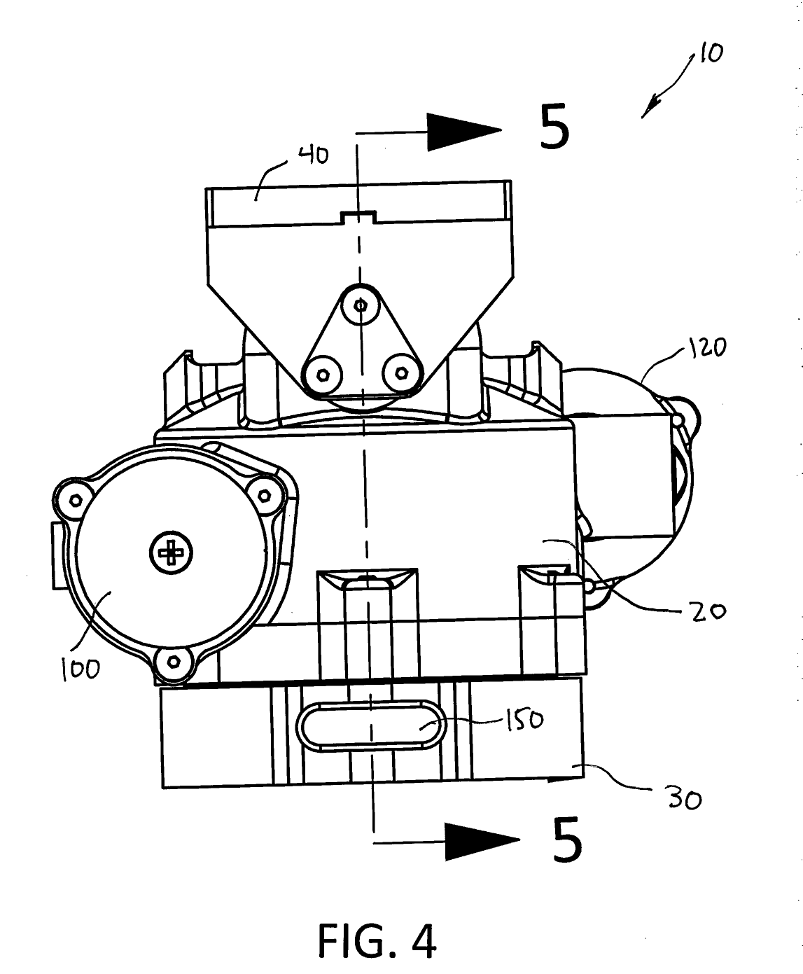

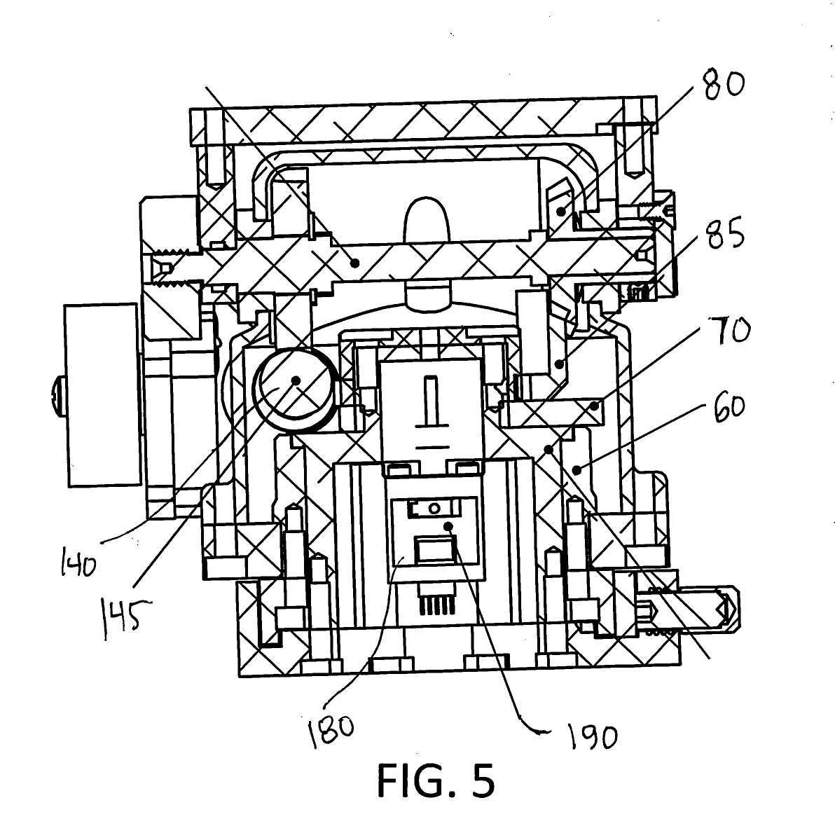

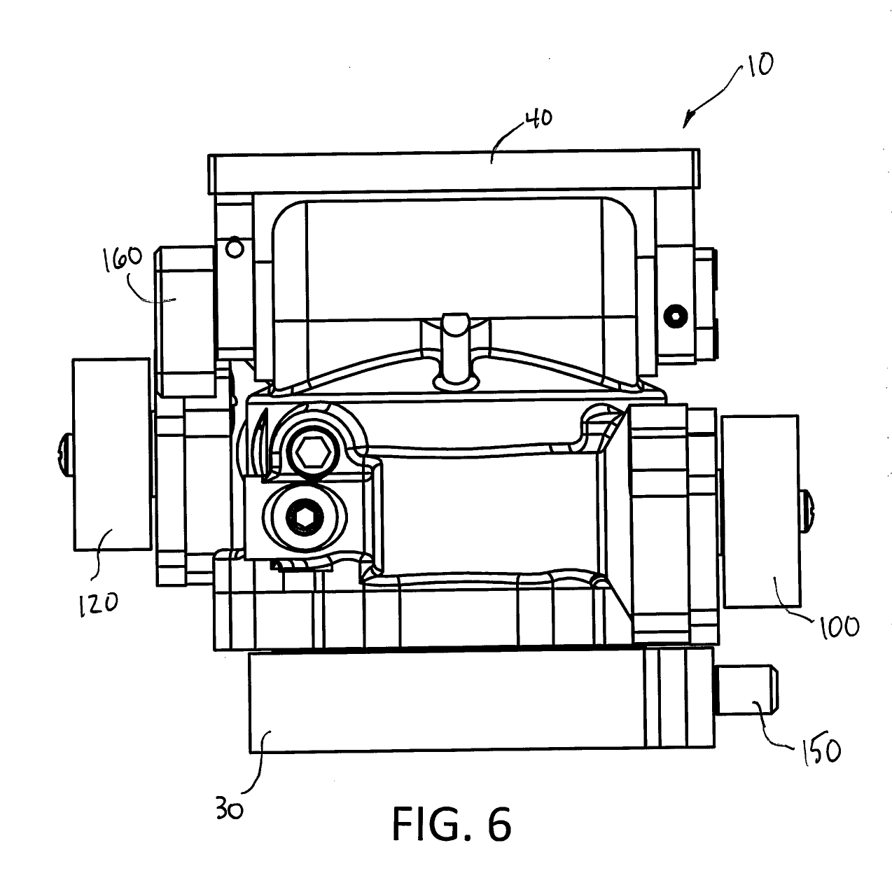

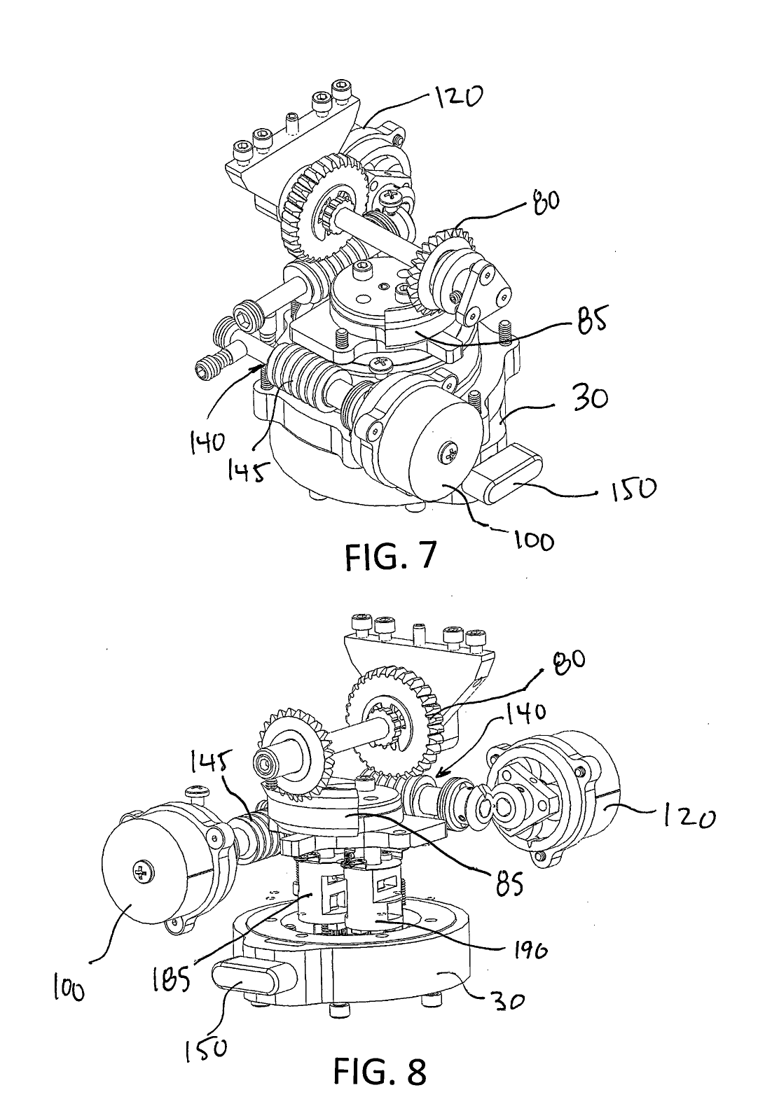

According to a preferred embodiment of this invention, an adjustable positioning device or adjustable head 10, such as a tripod head, having a range of motion around a horizontal axis and a range of motion around a vertical axis, is adaptable for use with a tripod and/or in connection with any number of accessories or components. Although a tripod head is used by way of example any suitable positioning device may be configured in accordance with the present invention. Accessories may include sighting systems, such as telescopes and binoculars; weapon systems, such as rockets and guns; surveillance systems, such as cameras; and positioning and/or guidance systems, such as lasers. FIGS. 1-11 show various features and/or preferred embodiments of the subject invention.

The adjustable head 10 preferably includes a housing 20. The housing 20 is preferably constructed of materials that provide torsional rigidity. In addition, the housing 20 is preferably finished and corrosion and weather resistant. In particular, the housing 20 is preferably capable of withstanding wet and otherwise corrosive environments; high (+165 degrees F.) and/or low (−40 degrees F.) temperature environments; may operate in high winds (155+ mph); high humidity and/or any other possible environment suitable for the positioning device 10 such as disclosed herein. The housing 20 may include one or more sidewalls which are sealed to and removably attached to the housing 20 to facilitate access and/or adjustment to the mechanical internals, described in detail below.

As shown in FIGS. 1-8, a mounting base 30 is positioned outside of the housing 20. The mounting base 30 preferably permits attachment of the tripod head to a mounting surface, such as a fixed surface, such as a tripod. The mounting base 30 is preferably fixable to the tripod (or similar platform or surface) to enable free motion of the housing 20 relative to the tripod.

As shown in FIGS. 1-6, a platform 40 is positioned with respect to the housing 20, opposite the mounting base 30. The platform 40 is preferably configured to rotate with the housing 20 as described in more detail below. As such, the platform 40 is preferably configured to rotate around with the housing 20 in a first axis (“pan”) and fore and aft with the housing 20 in a second axis (“tilt”). The adjustable head 10 as described herein is preferably configured to continuously pan around the first axis and tilt around the second axis within the natural range and/or physical limits of the housing 20. The platform 40 is preferably configured to permit attachment of a desired device or accessory, such as a telescope or similar sighting system.

The associated accessory may include any number of devices, however, as generally described herein, the accessory comprises a sighting system, such as a telescope. Alternatively, the accessory may include a camera, such as a standard video camera, an infra-red camera or a stop action camera; a positioning system; and/or a thermal imaging system.

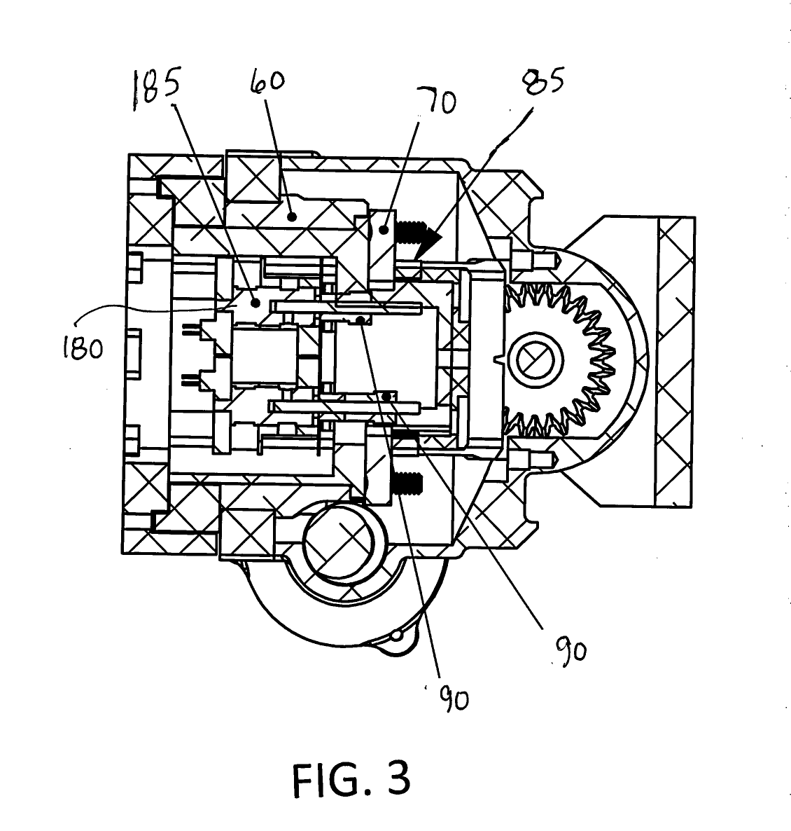

The mechanical internals of the adjustable head 10 are best shown according to various preferred embodiments of the invention in FIGS. 3, 5, 7, 8 and 11 and preferably include a pan adjustment gear 60 and a tilt adjustment gear 80 positioned within the housing 20. As shown in the figures, a preferred arrangement within the housing 20 includes the tilt adjustment gear 80 positioned within an upper portion of the housing 20 and a pan adjustment gear 60 positioned with a lower portion of the housing 20. In this arrangement, described in more detail as follows, is it possible to locate the necessary mechanicals within the housing 20 to permit infinite and continuous fine and coarse adjustment and maintain continuous feedback during the same.

The pan adjustment gear 60 is preferably configured to enable a panning motion of the adjustable head 10 about a first axis. The tilt adjustment gear 80 is preferably configured to enable a tilting motion of the adjustable head 10 about a second axis, preferably perpendicular to the first axis. The pan adjustment gear 60 and/or tilt adjustment gear 80 preferably include one or more interactive gears and/or any other suitable arrangement that permits the adjustable head 10 to move in a pan (azimuth) direction and/or a tilt (pitch/elevation) direction. According to a preferred embodiment of this invention, the pan adjustment gear 60 is infinitely tine adjustable continuously around its respective axis of rotation.

As shown in FIGS. 1-8, the adjustable head 10 preferably includes a pan adjustment knob 100 and a tilt adjustment knob 120 positioned on an exterior of the housing 20. Each of the pan adjustment knob 100 and the tilt adjustment knob 120 control a respective fine adjustment in a continuous manner. That is, once a coarse adjustment has been dialed in, the adjustable head 10 may be adjusted finely using a respective external knob continuously without resetting the coarse adjustment or otherwise repositioning the tripod.

According to one preferred embodiment of this invention, the tilt adjustment gear 80 and the pan adjustment gear 60 are each coarse adjustable and, once coarse adjustment of the adjustable head 10 is locked into position, fine adjustment is enabled or unlocked. According to a preferred embodiment of this invention, a coupler 140 is positioned in connection with the pan adjustment gear 60, wherein the coupler 140 locks coarse adjustment of the pan adjustment gear 60 and enables fine adjustment of the pan adjustment gear 60. According to one preferred embodiment of this invention, the coupler 140 comprises a self-locking but robust gear system such as a worm gear 145. Likewise, a similar coupler may be used in connection with the tilt adjustment gear 80 to lock coarse adjustment and enable fine adjustment.

As shown in the figures, the coupler 140 may be connected with respect to a pan brake knob 150 and/or a tilt brake knob 160 positioned external to the housing 20. The respective pan brake knob 150 and/or tilt brake knob 160 may be released to disengage a respective adjustment gear 60, 80 and permit free movement of the tripod head in the pan axis and/or the tilt axis, respectively. When the respective brake knob 150, 160 is engaged, this may accordingly engage fine adjustment of the adjustable head 10 using the aforementioned pan adjustment knob 100 and/or tilt adjustment knob 120.

According to a preferred embodiment of this invention, the adjustable head 10 enables continuous feedback from any and all fine and coarse adjustments of the adjustable head 10 to ensure that the position is continuous recordable and/or identifiable. As such, adjustable head 10 preferably further includes a pan feedback gear 70 and a tilt feedback gear 90, connected with a pan adjustment gear 60 and a tilt adjustment gear 80, respectively. In addition, each of pan feedback gear 70 and the tilt feedback gear 90 are connected with respect to a respective feedback device 180, such as an encoder, to enable continuous feedback.

According to a preferred embodiment of this invention, a feedback coupling gear 85 is positioned between the tilt adjustment gear 80 and the tilt feedback gear 90. The feedback coupling gear 85 preferably includes a plurality of inwardly extending teeth arranged around an inner ring and a plurality of upwardly extending teeth arranged at least partially around a circumference of the inner ring. The tilt feedback gear 90 is preferably a shaft gear positioned to mesh with the inwardly extending teeth of the inner ring.

As described above, a respective feedback device 180 is preferably positioned in communication with a respective feedback gear 70, 90. As such, a tilt feedback device 185 and a pan feedback device 190 are preferably positioned within the housing 20. Each of the pan feedback device 185 and the tilt feedback device 190 preferably comprises a respective encoder. As described, both the pan adjustment gear 60 and the tilt adjustment gear 80 each provide continuous feedback for both coarse adjustment and fine adjustment.

The adjustable head 10 as described herein preferably includes a pan adjustment gear 60 and a tilt adjustment gear 80, specifically for application in an adjustable head 10 that pans and tilts, however, this invention is not limited to an adjustable head 10 having both a pan adjustment gear 60 and a tilt adjustment gear 80. The principles of the described invention work equally well for an adjustable head 10 having only a pan adjustment gear 60, only a tilt adjustment gear 80 and/or any other belt, pulley, gear or combination thereof.

The adjustable head 10 includes a housing 20 that preferably permits continuous rotation capabilities and approximately 180 degree (preferably ±100 and more preferably ±90 degrees) tilt rotation capabilities.

The adjustable head 10 preferably includes internal mechanicals that may accommodate hard limits and/or soft limits for limiting a fixed range of motion for the tilt and/or the pan. Such limits may be useful in particular applications requiring that the component and/or positioning device 10 be limited to a particular range of motion, i.e. because of physical restrictions of the mounting environment, particularly in the up and down movements, or tilt rotation.

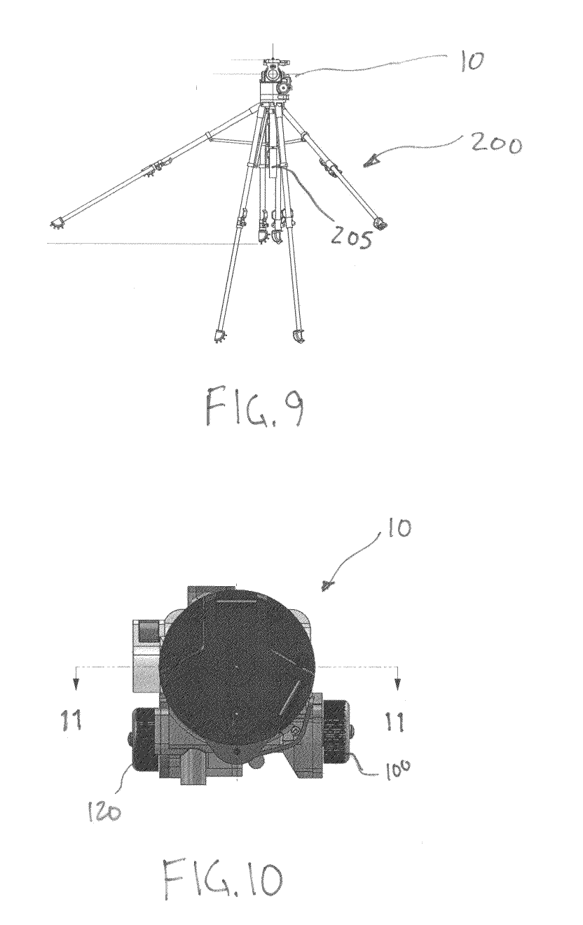

Accordingly, a method of adjusting an adjustable head 10 for use in connection with a tripod, such as shown in FIG. 9, includes providing the tilt adjustment gear 80 and the pan adjustment gear 60 within the housing 20 and enabling continuous and infinite fine adjustment of each, around respective axes of rotation. Moreover, coarse adjustment is preferably lockable to enable fine adjustment of the pan and/or tilt adjustment gear 60, 80. In addition, the subject invention provides continuous feedback from both fine adjustment and coarse adjustment of the pan and/or the tilt feedback gear 60, 80.

Although as described, the adjustable head 10 may be manually operated by a user, alternatively, the adjustable head 10 may be powered and operated remotely. The feedback system as described would enable such remote operation and the associated accessory may be additionally powered and/or controlled remotely to permit movement, control and/or powering of the accessory through the positioning device 10.

According to a preferred embodiment of this invention, the adjustable head 10 may further include a controller (not shown) in communication with internals of the adjustable head 10. The controller may be used to control, program and/or operate the adjustable head 10, directly and/or remotely.

The housing 20 is preferably constructed using fasteners and concealed wiring and connection points. Traditionally, one or more wires must extend from prior art adjustable heads, however, the subject invention may further include a power supply, such as a battery 205, located within one or more strut tubes within a tripod 200, such as that shown in FIG. 9.

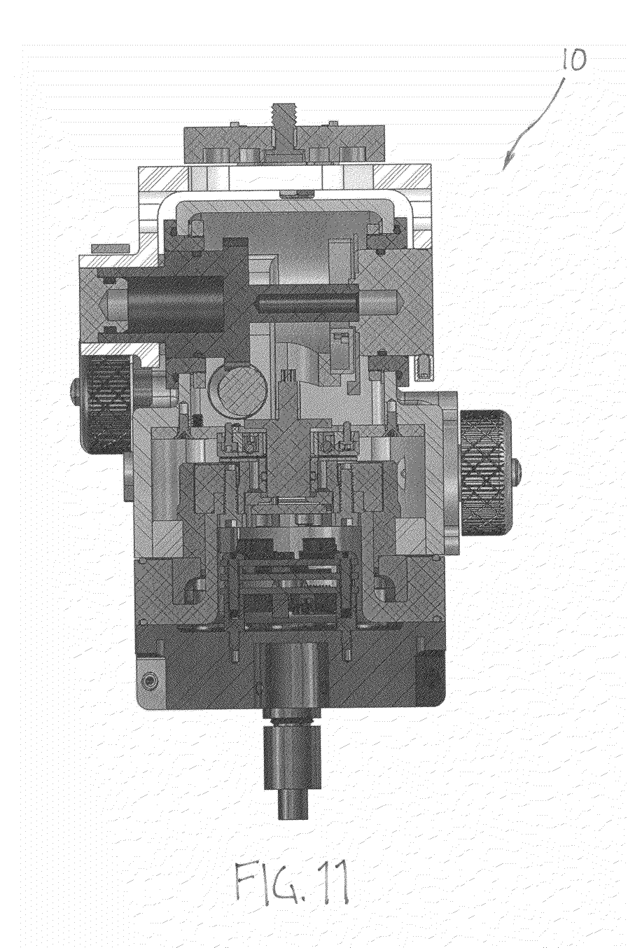

According to a preferred embodiment of the adjustable head 10, shown in FIGS. 10 and 11, one or more slip rings 130 may be positioned within the housing 20 to permit free rotation of the mounting base 30 relative to the platform 40. In this manner, wires or other fixed connections are not disturbed or tangled by the continuous rotation of the adjustable head 10 relative to the mounting surface.

While in the foregoing specification this invention has been described in relation to certain preferred embodiments thereof, and many details have been set forth for purpose of illustration, it will be apparent to those skilled in the art that the method and apparatus according to this invention are susceptible to additional embodiments and that certain of the details described herein can be varied considerably without departing from the basic principles of the invention.

We claim:

1. An adjustable head for use in connection with a mounting surface comprising:
a housing;
a tilt adjustment gear positioned within the housing, wherein the tilt adjustment gear is fine adjustable through a range of tilt travel;
a pan adjustment gear positioned within the housing, wherein the pan adjustment gear is infinitely fine adjustable continuously around an axis of rotation.

2. The adjustable head of claim 1 further comprising:
a pan engagement knob; and
a tilt engagement knob, wherein each of the pan engagement knob and the tilt engagement knob control fine adjustment in a continuous manner.

3. The adjustable head of claim 1 wherein the tilt adjustment gear and the pan adjustment gear are each coarse adjustable and wherein coarse adjustment may be decoupled to couple fine adjustment.

4. The adjustable head of claim 3 further comprising a coupler positioned in connection with the pan adjustment gear, wherein the coupler locks coarse adjustment.

5. The adjustable head of claim 4 wherein the coupler comprises a self-locking gear.

6. The adjustable head of claim 1 further comprising:
a tilt feedback gear; and
a pan feedback gear, each of the tilt feedback gear and the pan feedback gear connected with respect to a respective feedback device to enable continuous feedback.

7. The adjustable head of claim 4 further comprising:
a feedback coupling gear positioned between the tilt adjustment gear and the tilt feedback gear, wherein the feedback coupling gear includes a plurality of inwardly extending teeth arranged around an inner ring and a plurality of upwardly extending teeth arranged at least partially around a circumference of the inner ring.

8. The adjustable head of claim 1 further comprising:
a tilt feedback device and a pan feedback device positioned within the housing.

9. The adjustable head of claim 8 wherein each of the tilt feedback device and the pan feedback device comprises a respective encoder.

10. The adjustable head of claim 7 wherein both the tilt feedback gear and the pan feedback gear each provide continuous feedback for both coarse adjustment and fine adjustment.

11. The adjustable head of claim 1 wherein the tilt adjustment gear is positioned above the pan adjustment gear within the housing.

12. An adjustable head for use in connection with a tripod comprising:
a housing;
a pan adjustment gear within the housing, the pan adjustment gear configured to rotate the housing around a first axis;
a tilt adjustment gear within the housing, the tilt adjustment gear configured to rotate the housing around a second axis, perpendicular to the first axis;
a pan adjustment knob connected with respect to the pan adjustment gear, the pan adjustment knob permitting a continuous and infinite coarse adjustment and a continuous and infinite fine adjustment of the pan adjustment gear, wherein coupling the coarse adjustment enables the fine adjustment.

13. The adjustable head of claim 12 further comprising:
a tilt adjustment knob that controls fine adjustment of the tilt adjustment gear in a continuous manner through a natural range of tilt.

14. The adjustable head of claim 12 wherein the tilt adjustment gear and the pan adjustment gear are each coarse adjustable, and coarse adjustment is coupled to decouple fine adjustment.

15. The adjustable head of claim 14 further comprising a self locking gearing system positioned in connection with the pan adjustment gear, wherein the self locking gearing system comprises a coupler to lock coarse adjustment.

16. The adjustable head of claim 12 further comprising:
a tilt feedback gear; and
a pan feedback gear, each of the tilt feedback gear and the pan feedback gear connected with respect to a respective feedback device to enable continuous feedback.

17. The adjustable head of claim 12 further comprising:
a slip ring positioned with respect to the pan adjustment gear to permit continuous rotation of the housing around the first axis.

18. A method of adjusting a head for use in connection with a tripod comprising:
providing a tilt adjustment gear within a housing;
providing a pan adjustment gear within the housing;
enabling continuous fine adjustment of the tilt adjustment gear within a natural path of travel and continuous and infinite fine adjustment of the pan adjustment gear, around respective axes of rotation.

19. The method of adjusting a head for use in connection with a tripod of claim 18 further comprising:
coupling coarse adjustment of the pan adjustment gear to enable fine adjustment of the pan adjustment gear.

20. The method of adjusting a head for use in connection with a tripod of claim 18 further comprising:
providing continuous feedback from both fine adjustment and coarse adjustment of the pan adjustment gear.

21. The method of adjusting a head for use in connection with a tripod of claim 20 further comprising:
providing continuous feedback from both fine adjustment and coarse adjustment of the tilt adjustment gear.
